(19) United States
(12) Patent Application Publication
(10) Pub. No.: US 2017/0178478 A1
(43) Pub. Date: Jun. 22, 2017

(54) REDUCTION OF FALSE ALARMS IN EAS SYSTEMS

(71) Applicant: Checkpoint Systems, Inc., Thorofare, NJ (US)

(72) Inventor: Joseph R. Galanti, Blackwood, NJ (US)

(21) Appl. No.: 14/974,822

(22) Filed: Dec. 18, 2015

(51) Int. Cl. G08B 13/24

(52) U.S. Cl. CPC G08B 13/2431

(57) ABSTRACT

A tag monitoring device configured to interface with a security tag adapted to be disposed on a corresponding product in a monitoring environment may include a transmitter, a receiver and processing circuitry. The transmitter transmits a periodic signal pulse during a transmit cycle. The receiver monitors for a response from the security tag after the transmit cycle. The processing circuitry is configured to control the receiver with respect to enabling the receiver to detect the response. The processing circuitry is configured to perform dynamic tuning of the receiver or transmitter.

### TECHNICAL FIELD

Various example embodiments relate generally to retail theft deterrent and merchandise protection devices, and more particularly relate to methods and devices for improving the detection capabilities of devices that detect security tags employed for such purposes.

### BACKGROUND

Security devices have continued to evolve over time to improve the functional capabilities and reduce the cost of such devices. Some security devices are currently provided to be attached to individual products or objects in order to deter or prevent theft of such products or objects. In some cases, the security devices include tags or other such components that can be detected by gate devices at the exit of a retail establishment or tracked while being moved in the retail establishment. These tags may sometimes also be read for inventory management purposes, and may include or otherwise be associated with specific information about the type of product to which they are attached.

In order to improve the ability of retailers to deter theft or manage inventory, the security devices and systems in which they operate are continuously being improved. For example, various improvements may be introduced to attempt to improve the ability of gates placed at the exits of retail establishments to detect the tags. In this regard, the gates may occasionally produce false alarms or fail to detect tags passing through the gates. When such situations are noted, field servicing and the corresponding costs associated therewith may be incurred to try to optimize system performance. Additionally, the initial setup of the system may be an onerous task aimed at trying to optimize system performance.

Accordingly, the ability to provide good accuracy of detecting the tags with relatively little setup and maintenance may be considered to be an important aspect when determining the appropriate balance of characteristics for a given system.

### BRIEF SUMMARY OF SOME EXAMPLES

Some example embodiments may improve the accuracy of tag detection, but do so in a way that can provide for automated system optimization so that there is not difficulty in initializing and maintaining the system. In this regard, some example embodiments may enable an automatic optimization detection tuning process to be conducted. In some examples, the automatic optimization of detection tuning may include an automatic adjustment to account for resonance noise for each receiver in the system. The automatic optimization detection tuning process may be employed to improve system performance without the need for repeated service calls. Thus, the cost of field service and support may be reduced and the opportunity for a plug & play electronic article surveillance (EAS) system may be realized. Optimal tuning may also reduce the occurrence of false alarms.

In one example embodiment, a tag monitoring device configured to interface with a security tag adapted to be disposed on a corresponding product in a monitoring environment is provided. The tag monitoring device may include a transmitter, a receiver and processing circuitry. The transmitter transmits a periodic signal pulse during a transmit cycle. The receiver monitors for a response from the security tag after the transmit cycle. The processing circuitry is configured to control the receiver with respect to enabling the receiver to detect the response. The processing circuitry is configured to perform dynamic tuning of the receiver or transmitter by measuring a plurality of signal and noise levels for each of a plurality of bins of frame data associated with a first transmit port and first receiver port, and a second transmit port and second receiver port, determining difference information indicative of a difference between the signal and noise levels for each of the bins, adjusting a noise threshold of selected ones of the bins based on the difference information, and selectively adjusting transmitter gain based on detection of an alarm trigger condition.

According to another example embodiment, a security system is provided. The security system may include at least one security tag disposed on a product in a monitoring environment, and a tag monitoring device configured to interface with the at least one security tag. The tag monitoring device may include a transmitter, a receiver and processing circuitry. The transmitter may be configured to transmit a periodic signal pulse during a transmit cycle. The receiver may be configured to monitor for a response from the security tag after the transmit cycle. The processing circuitry may be configured to control the receiver with respect to enabling the receiver to detect the response. The processing circuitry is configured to perform dynamic tuning of the receiver or transmitter by measuring a plurality of signal and noise levels for each of a plurality of bins of frame data associated with a first transmit port and first receiver port, and a second transmit port and second receiver port, determining difference information indicative of a difference between the signal and noise levels for each of the bins, adjusting a noise threshold of selected ones of the bins based on the difference information, and selectively adjusting transmitter gain based on detection of an alarm trigger condition.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a signal diagram to facilitate a description of EAS system tuning according to an example embodiment;

FIG. 2 illustrates a conceptual diagram of a monitoring environment within a retail store according to an example embodiment;

FIG. 3 illustrates a block diagram of tag monitoring equipment (or a tag monitoring device) that may be employed to monitor tags that may be placed on objects in the monitoring environment in accordance with an example embodiment;

FIG. 4 illustrates a tuning and resonance noise detection algorithm that may be employed for dynamic tuning in accordance with an example embodiment; and

FIG. 5 illustrates a block diagram of an automatic tuning process in accordance with an example embodiment.

### DETAILED DESCRIPTION

Some example embodiments now will be described more fully hereinafter with reference to the accompanying drawings, in which some, but not all embodiments are shown. Indeed, the examples described and pictured herein should not be construed as being limiting as to the scope, applicability or configuration of the present disclosure. Like reference numerals refer to like elements throughout. Furthermore, as used herein, except where otherwise specified, the term “or” is to be interpreted as a logical operator that results in true whenever one or more of its operands are true. As used herein, “operable coupling” should be understood to relate to direct or indirect connection that, in either case, enables at least a functional interconnection of components that are operably coupled to each other.

Of note, an example embodiment will be described in the context of a high frequency pulse (e.g., 3 MHz to 30 MHz). However, other periodic signals or waveforms (e.g., sinusoids, square waves, etc), having corresponding other frequencies that are generated for a finite period of time followed by a generally longer off period may also be employed.

As used in herein, the terms “component,” “module,” and the like are intended to include a computer-related entity, such as but not limited to hardware, firmware, or a combination of hardware and software. For example, a component or module may be, but is not limited to being, a process running on a processor, a processor, an object, an executable, a thread of execution, or a computer. By way of example, both an application running on a computing device or the computing device can be a component or module. One or more components or modules can reside within a process or thread of execution and a component/module may be localized on one computer or distributed between two or more computers. In addition, these components can execute from various computer readable media having various data structures stored thereon. The components may communicate by way of local or remote processes such as in accordance with a signal having one or more data packets, such as data from one component/module interacting with another component/module in a local system, distributed system, or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior or capability of the processing circuitry based on the hardware or software that is added to or otherwise operably coupled to the processing circuitry to configure the processing circuitry accordingly.

Some example embodiments may relate to improvement of a system and devices capable of detecting security devices (e.g., tags) that are attached to objects such as retail products. Detection of the tags may sometimes occur within the context of electronic article surveillance (EAS). EAS gates may be provided at a location, such as the exit of a store, to detect tags that have not been removed or deactivated from products by a store clerk when properly purchased at a point of sale. The EAS gates at store exits are familiar sights, in the form of detection pedestals. The EAS gates may use magnetic, acousto-magnetic, radio frequency (RF), microwave, combinations of the above, or other detection methods for detecting tags.

When RF tags are employed, the tags are often designed as essentially an LC tank circuit with a resonance peak in a desired frequency band. The EAS gates can sweep around the resonant frequency to detect the presence of an RF tag. The RF tags can be removed at the point of sale, or can be deactivated using a deactivator that is configured to submit the RF tag that is to be deactivated to a strong electromagnetic field that can break down, for example, a capacitor of the LC tank circuit. The deactivator may, in some cases, be a deactivation pad over which the RF tags are passed for deactivation.

In some cases, EAS devices that employ RF sensing have a pulsed high frequency (HF) amplifier to provide current to drive either deactivation pads or detection pedestals. The pulsating high current condition does not immediately dissipate after a pulse is generated. Instead, due to the various interactions created by the circuitry that is operably coupled to these components, there may be some ringing and settling that occurs after the pulse is generated. Accordingly, after RF is disabled between different interfacing antennas and pedestals, corresponding different ringing and settling times may be experienced. If the electronics (i.e., the circuitry) of such components is not allowed to settle properly before enabling receivers of such devices to attempt subsequent detections, the receivers may essentially hear themselves and cause a false alarm. In other words, if the receiver is enabled while ringing is occurring before the circuitry has settled, the receiver may detect the ringing and trigger a false alarm.

Noise levels experienced by the system can also impact the detection capabilities of the system, and the frequency of experiencing false alarms. Random noise is considered asynchronous to a typical detection system and can be caused by sweepers, lighting, door motors, or other electrical components within a retail monitoring environment. In most cases, the random noise is not a false alarm threat because the alarm level is set as a multiple of the random noise level. For example, if the average random noise level is measured, the detection threshold for triggering an alarm may be set to four times the average random noise level (or some other multiple of the average random noise level). Although random noise is not necessarily a false alarm threat, the random noise can cause loss of detection by reducing the signal to noise ratio (SNR).

False alarm threats are typically instead associated with synchronous noise, or resonance noise. External resonance noise is the leading cause of false alarming. Moreover, in some cases, resonance noise may actually be very hard to find in an installation environment. Resonance noise can be caused, for example, by the transmit signal causing some structure (e.g., a metal structure such as a rack or door) to become a re-radiator. The re-radiation will, in most cases, be synchronized with the transmit cycle, and thus, the resonance noise typically looks like a tag signal, which can potentially cause false alarms. This is the case if the Q of the external structure is within range of the tag.

When a resonance noise source is found, and cannot be identified, the field technician will typically reduce the transmit level or reduce the receiver gain. In some cases, the unidentified resonance may not cause a problem because the unidentified resonance will not meet the Q range requirements, and therefore will not cause a false alarm. Despite this, the field technician may still reduce (or otherwise adjust) either or both the transmit level and the receiver gain. In some cases, just reducing the receiver gain may be sufficient so that transmit level need not be changed. However, in either case, the transmit level or receiver gain may be unnecessarily adjusted and may contribute to false alarms being experienced.

There are also cases where the emission may be background-subtracted, and the emission may not be obvious, but could still cause false alarms if either the item causing the resonance is moved, or fluctuations occur in either the transmitter output or noise in the receiver. This type of problem may exist after installation because of the stationary nature of the item causing the problem (e.g., the reflection and re-radiation). Thus, for example, false alarms may be reported due to movement of a re-radiating structure. However, when the field technician arrives to check the system, the re-radiating structure may be stationary so that the problem is not detectable.

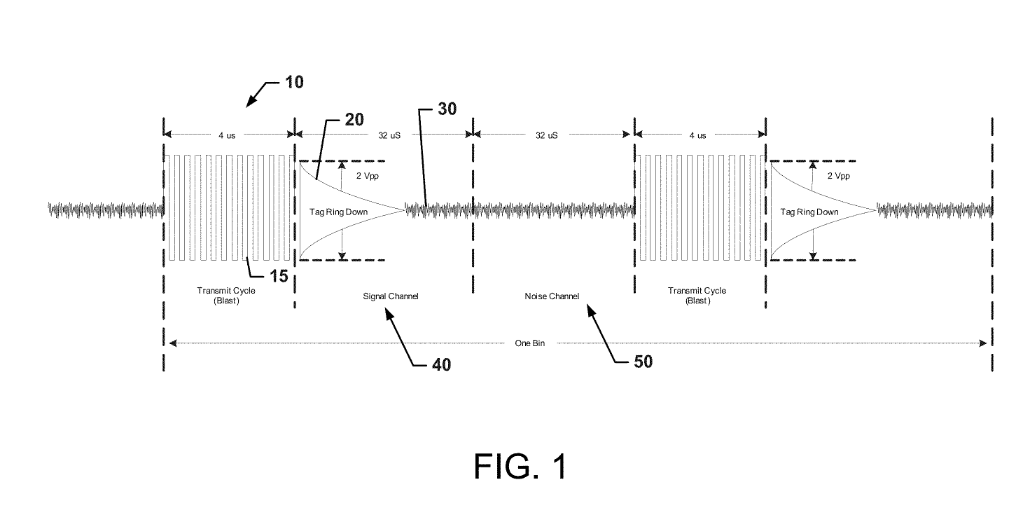

Example embodiments may therefore be employed to avoid this situation by providing an executable algorithm that effectively moves the reflector or re-radiator by fluctuating transmitter characteristics and measuring SNR to see if values are building up for the receiver/transmitter in a way that indicates the existence of a reflection issue. FIG. 1 illustrates a signal diagram to facilitate a description of EAS system that may be tuned according to an example embodiment. As shown in FIG. 1, there may be an initial transmit cycle 10 (or blast of a periodic signal 15) for a given period of time (e.g., 4 μs). After the transmit cycle 10 is disabled, the tuned resonances (e.g., capacitance and inductance) of the electronic components in the system take time to discharge or settle out. Thus, a ring down signal 20 (or tag ring down) is generated. The ring down signal 20 may eventually reach the ambient noise level 30, and become lost in the noise.

The raw data from the receiver within the system may be segmented into frames, with each frame including 32 bins (resulting from each pulsed frequency). Each frequency unique bin may include two blasts. Each blast may include a signal channel 40 and a noise channel 50. In this example, each of the signal channel 40 and the noise channel 50 are about 32 μs in duration. This provides about 64 μs of spacing between the two blasts.

The raw data from the hardware receiver is sampled and signal processing is applied to filter out noise spikes (e.g., via a median filter). The signal processing also processes many frames to remove random noise and use correlation to identify and increase the tag signal ring down (e.g., ring down signal 20). The signal processing also calculates phase and Q between the two blasts of a given bin and applies software gain to the signal to provide a method to remove standing resonances (e.g., via a high pass filter).

Each stage of this signal processing provides data for a microcontroller or processing circuitry of the system or a test device (e.g., a service tool) that may be used to display the data. In some cases, the service tool may be configured to provide a plurality of display views. In one particular situation, the views may include an A view having raw data from the receiver, a B view showing the data after application of a median filter, a C view showing the data after random noise has been removed and software gain has been applied to the signal, and a D view showing the signal with standing resonances removed using a high pass filter.

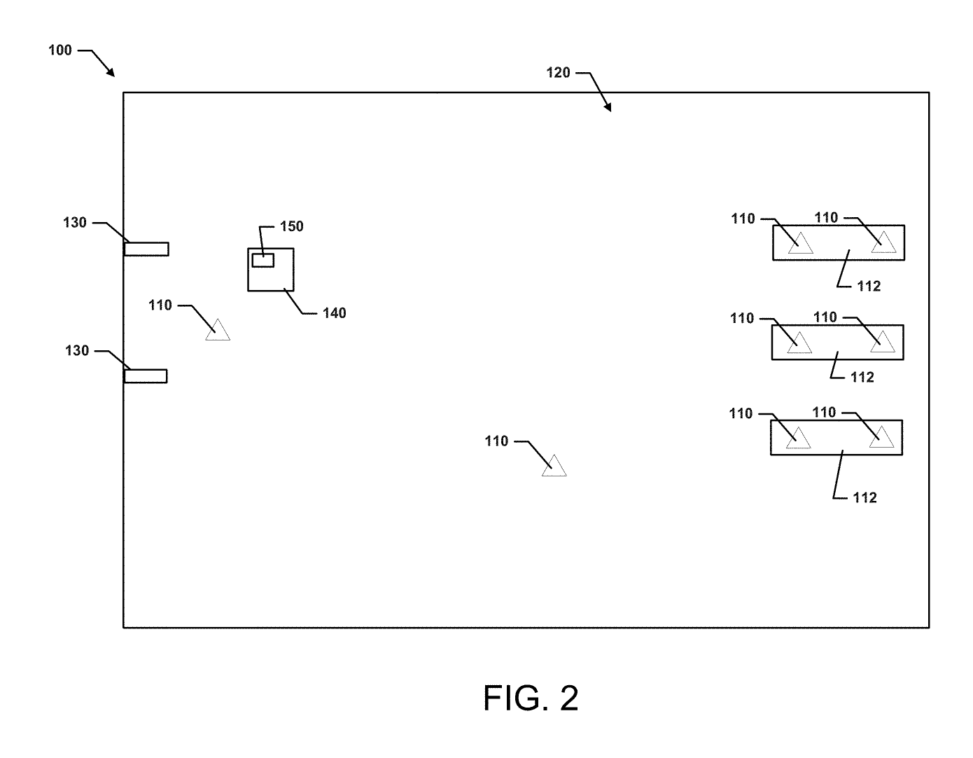

The field technician may have difficulty in determining when optimal tuning has been achieved relative to the occurrence of resonance noise, as mentioned above. This may lead to improper tuning, which may lead to false alarms for the system. Some example embodiments may therefore employ a resonance noise detection module to test whether resonance noise sources such as reflectors are present and optimally tune the system to reduce the likelihood of false alarms from resonance noise. FIG. 2 illustrates a conceptual diagram of a monitoring environment 100 within a retail store. As shown in FIG. 2, the monitoring environment 100 may include a monitoring zone 120, which may represent a relatively large area of the store (e.g., the sales floor). Tags 110 may generally be monitored while they are in the monitoring zone 120, and a detection pedestal 130 may be provided at an exit from the monitoring zone 120 to detect passage of the tags 110 through the EAS gates provided by the detection pedestal 130. As shown in FIG. 2, the tags 110 may be disposed on products that may be provided on various product displays or racks 112, which may be at various locations throughout the monitoring zone 120.

The monitoring environment 100 may also include a point of sale 140 at which retail items may be purchased. At the point of sale 140, the store clerk may take payment for the products to which the tags 110 are attached. The store clerk may also employ a deactivator 150 at the point of sale 140 in order to deactivate the tags 110 after the purchasing transaction is completed for a tagged product.

Based on the description above, it can be appreciated that both the deactivator 150 and the detection pedestal 130 may interact with the tags 110 at various times. In particular, when one of the tags 110 is brought into a field generated by the detection pedestal 130, the corresponding one of the tags 110 may be detected by the detection pedestal 130. The deactivator 150 may interact with one of the tags 110 when such tag is brought into contact with or proximate to the deactivator 150 in order to deactivate the corresponding one of the tags 110 prior to passage through the detection pedestal 130 so that the corresponding one of the tags 110 is not detected.

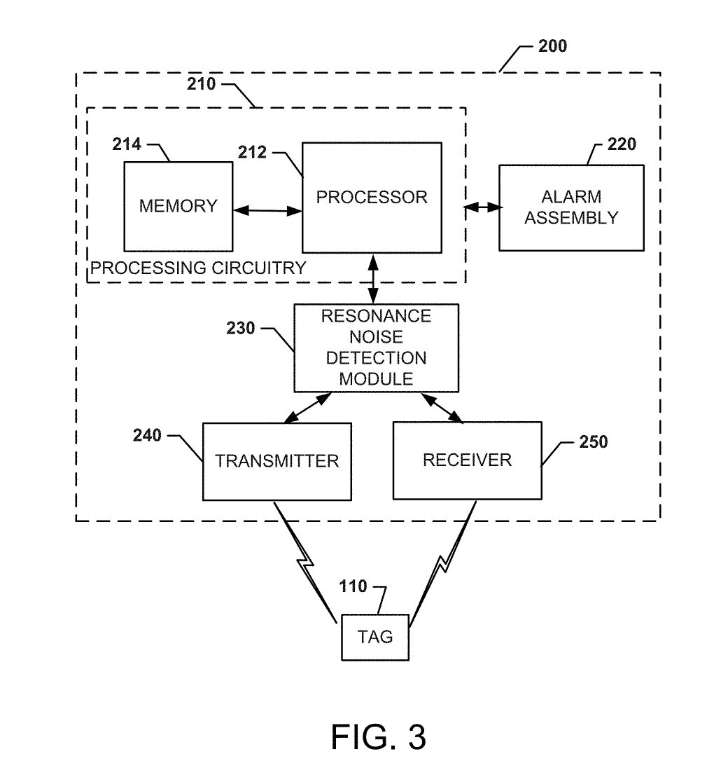

The detection pedestal 130 may include, be embodied as or otherwise be in communication with tag monitoring equipment 200 of an example embodiment. In this regard, the tag monitoring equipment 200 may include components, modules and or processing circuitry that are configured or configurable to enable the tag monitoring equipment 200 to detect the presence of one of the tags 110 at the detection pedestal 130 so that, for example, alarm functionality may be initiated. FIG. 3 illustrates a block diagram of tag monitoring equipment 200 (or a tag monitoring device) that may be employed to monitor tags 110 that may be placed on objects (products) in the monitoring environment 100 in accordance with an example embodiment.

In some cases, the differences or deltas between signal and noise channels may be collected to independently adjust the noise threshold of each bin. This may be accomplished by identifying whether a signal above the noise could potentially cause a false alarm. If so, the newly found noise threshold may be used to measure whether a tag signal exceeds the new threshold. This is a different approach from just decreasing the transmit level for a particular receiver port to reduce false alarm threat. Instead, the new approach only affects the bins in which the resonance appears, and does not affect other bins for a given port. Furthermore, the automatic tuning provided by example embodiments adjusts the transmitter level during the test to indicate whether a standing resonance, if disturbed in the monitoring environment 100, would cause a false alarm. This is important because in many monitoring environments, the resonance seems to be harmless because it is background-subtracted. But as soon as the device causing the resonance is moved or an internal fluctuation occurs in the transmitter or receiver level, a false alarm may occur. In a worst case scenario, the automatic tuning may need to reduce the transmitter level.

As shown in FIG. 3, the tag monitoring equipment 200 may include processing circuitry 210 configured in accordance with an example embodiment as described herein. In this regard, for example, the tag monitoring equipment 200 may utilize the processing circuitry 210 to provide electronic control inputs to one or more functional units (which may be implemented by or with the assistance of the of the processing circuitry 210) of the tag monitoring equipment 200 to receive, transmit or process data associated with the one or more functional units and perform communications necessary to enable detection of tags, issuing of alarms or alerts, deactivation of tags or the like as described herein.

In some embodiments, the processing circuitry 210 may be embodied as a chip or chip set. In other words, the processing circuitry 210 may comprise one or more physical packages (e.g., chips) including materials, components or wires on a structural assembly (e.g., a baseboard). The structural assembly may provide physical strength, conservation of size, or limitation of electrical interaction for component circuitry included thereon. The processing circuitry 210 may therefore, in some cases, be configured to implement an embodiment on a single chip or as a single “system on a chip.” As such, in some cases, a chip or chipset may constitute means for performing one or more operations for providing the functionalities described herein.

In an example embodiment, the processing circuitry 210 may include one or more instances of a processor 212 and memory 214. As such, the processing circuitry 210 may be embodied as a circuit chip (e.g., an integrated circuit chip) configured (e.g., with hardware, software or a combination of hardware and software) to perform operations described herein. The processing circuitry 210 may interface with or control the operation of various other components of the tag monitoring equipment 200 including, for example, an alarm assembly 220, a transmitter 240 and a receiver 250. The processing circuitry 210 may also include, control or be embodied as a resonance noise detection module 230.

In an example embodiment, the processor 212 (or the processing circuitry 210) may be embodied as, include or otherwise control the resonance noise detection module 230 (or components thereof). As such, in some embodiments, the processor 212 (or the processing circuitry 210) may be said to cause each of the operations described in connection with the resonance noise detection module 230 (or components thereof) by directing the resonance noise detection module 230 (or respective components) to undertake the corresponding functionalities responsive to execution of instructions or algorithms configuring the processor 212 (or processing circuitry 210) accordingly.

The processor 212 may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to example embodiments while configured accordingly. Thus, for example, when the processor 212 is embodied as an ASIC, FPGA or the like, the processor 222 may be specifically configured hardware for conducting the operations described herein. Alternatively, as another example, when the processor 212 is embodied as an executor of software instructions, the instructions may specifically configure the processor 212 to perform the operations described herein. In some cases, the processor 212 may be embodied as a single entity, or may be distributed amongst other entities (e.g., such that processors of or associated with multiple components including the receiver 250, transmitter 240, or another entity cooperate with each other to perform various functions).

In an example embodiment, the memory 214 may include one or more non-transitory memory devices such as, for example, volatile or non-volatile memory that may be either fixed or removable. The memory 214 may be configured to store information, data, applications, instructions or the like for enabling the resonance noise detection module 230 to carry out various functions in accordance with example embodiments.

The alarm assembly 220 (if included) may include an audio device (e.g., a piezoelectric, mechanical, or electromechanical beeper, buzzer, or other audio signaling device such as an audible alarm). The alarm assembly 220 may include a speaker or other sound generating device. In some example embodiments, the alarm assembly 220 may also or alternatively include visible indicia (e.g., lights of one or more colors such as a bi-color (e.g., red/green) LED). The visible indicia of the alarm assembly 220 or the audio device thereof may be used in various ways to facilitate notification of the detection of one of the tags 110 by the tag monitoring equipment 200.

The transmitter 240 may include components and circuitry for transmission of an HF pulse that may be provided at a particular frequency (e.g., the resonant frequency of the tags 110) or may be swept over a range of frequencies around the resonant frequency of the tags 110. The transmitter 240 may also include a transmission antenna (or array of antennas), a signal generator, amplification circuitry, cabling or the like. The transmitter 240 may generate the HF pulse under the control of the processing circuitry 210 for timing control purposes.

After the HF pulse is transmitted, the receiver 250 may be enabled to listen for return signals generated responsive to receipt of the HF pulse by one of the tags 110. The receiver 250 may therefore include a receive antenna (or array of antennas), filters, signal processing circuitry, amplifiers, cabling or the like. In some cases, some of the components of the receiver 250 and the transmitter 240 may be shared between them. However, in other cases, the transmitter 240 and receiver 250 may each include distinct components. In an example embodiment, the receiver 250 may include multiple individual receivers (e.g., RX1 and RX2) that are individually controllable or tunable via the resonance noise detection module 230.

The receiver 250 or the transmitter 240 may be enabled for operation on a selective basis. In other words, the receiver 250 or the transmitter 240 may not continuously operate, but may instead have their on and off periods controlled by the processing circuitry 210. Similarly, the gain (or the multiplier) of the receiver 250 may be controlled by the processing circuitry 210 (e.g., via operation of the resonance noise detection module 230). In an example embodiment, the resonance noise detection module 230 may be any means such as a device or circuitry embodied in either hardware, or a combination of hardware and software that is configured to control the tuning of the receiver 250 or the transmitter 240. As such, the resonance noise detection module 230 may be configured to receive signal data measured at the receiver 250 and make adjustments to receiver noise thresholds or transmitter gain to determine whether any reflectors are in the vicinity of the receiver 250 or the system in general, and make tuning adjustments to avoid the occurrence of false alarms in the presence of such reflectors.

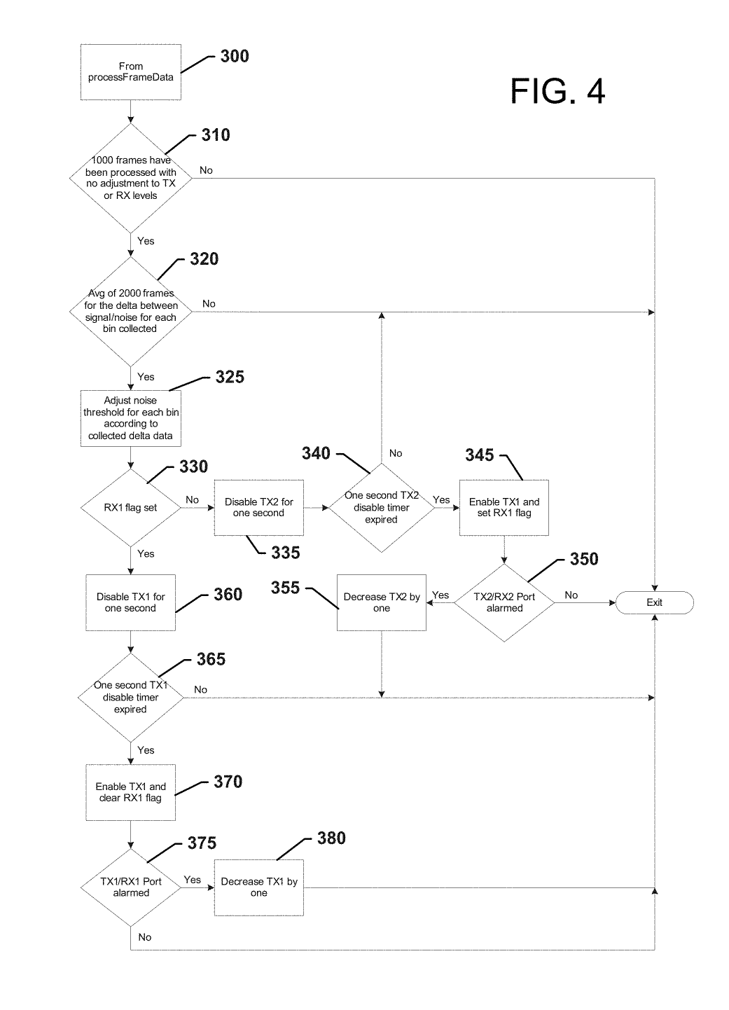

In an example embodiment, the resonance noise detection module 230 may be configured to operate by executing a resonance noise detection and tuning algorithm. FIG. 4 illustrates a block diagram of an example resonance noise detection and tuning algorithm of an example embodiment. As shown in FIG. 4, random noise data may initially be processed at operation 300 from frame data. In some cases, a predetermined number of frames (e.g., 1000 frames) may be processed with no adjustment to transmitter and receiver levels at operation 310. This may flush the buffer to ensure that old data is not used in any calculations associated with execution of the resonance noise detection process or algorithm. After at least the predetermined number of frames have been processed, flow may proceed to operation 320 at which frame data is averaged to determine a different (or delta) between the signal and noise for each bin collected. In some cases, the average may be made over a second predetermined number of frames (e.g., 2000 frames). This provides a running average of deltas for each bin's signal and noise measurements. After the averaging of the frame data is completed and the difference between signal and noise values for each bin has also been determined, the noise threshold may be adjusted at operation 325 for each bin based on the collected difference information from operation 320. As such, the different information (or delta data) is used to readjust the noise threshold for each independent bin according to the possible false alarm threat. To ensure that there is no false alarm threat, the transmitter for each port may be disabled for a predetermined period of time (e.g., 1 or 2 seconds), and then enabled at the original transmit level. If an alarm occurs after such procedure, then a readjustment is needed and the noise threshold and the transmit level for that particular port are reduced by a predetermined amount (e.g., 1). This process is demonstrated by operations 330 to 380 of FIG. 4.

In this regard, at operation 330, a first receiver (RX1) flag is checked to see if it is set. If it is not set, then a second transmitter (TX2) is disabled for one second at operation 335. A determination may then be made at operation 340 as to whether a disable timer has expired for the second transmitter (TX2). If the disable timer has expired, then the first transmitter (TX1) may be enabled and a flag may be set for RX1 at operation 345. Thereafter, at operation 350, a determination may be made as to whether the TX2/RX2 port has alarmed. If an alarm has occurred, then TX2 level (i.e., transmitter gain) may be decreased by a predetermined amount (e.g., 1) at operation 355.

If, at operation 330, the RX1 flag was set, then TX1 may be disabled for one second at operation 360. If the one second TX1 disable timer expires at operation 365, then TX1 may be enabled and the RX1 flag may be cleared at operation 370. A determination may then be made as to whether TX1/RX1 port has alarmed at operation 375, and if so, TX1 level (i.e., transmitter gain) may be decreased by the predetermined amount (e.g., 1) at operation 380.

In practice, adjusting the noise threshold is typically sufficient to enable a detection of standing resonance. In some cases, an indication may be provided (e.g., via a user interface that is operably coupled to the processing circuitry 210) or to a service tool. The indication may include, for example, a notification of the fact that transmit levels or thresholds have been changed. The indication may also include the levels/thresholds that were changed and the new levels/thresholds that are applicable after such changes in the form of results of the tuning operation shown in FIG. 4. In an example embodiment, a dedicated interface screen or page may be provided to display all configuration settings that have been changed. In some embodiments, the operations of FIG. 4 may be accomplished in an 8 ms interval (e.g., one frame sample period) for each iteration through the algorithm of FIG. 4.

As can be appreciated from the description above, the algorithm of FIG. 4 effectively moves any reflector that may be present in the monitoring environment 100 by fluctuating transmitter and taking signal and noise level measurements to see when such values are building for the corresponding receiver and transmitter. Example embodiments therefore set individual bin thresholds to affect alarm levels to account for resonance noise (rather than random noise) that may be present in a system.

In some example embodiments, the employment of resonance noise detection and tuning may be a selectable feature. Thus, for example, an operator may employ a service tool or otherwise select to enable the resonance noise detection module 230 to employ the algorithm of FIG. 4 to avoid overtuning and also detect the existence of potential reflectors that, if moved, may cause false alarms. Example embodiments may reduce the cost of field service support and may achieve optimal tuning to reduce detection losses. Example embodiments may also be useful in moving detection systems (e.g., EAS systems) toward a plug & play capability.

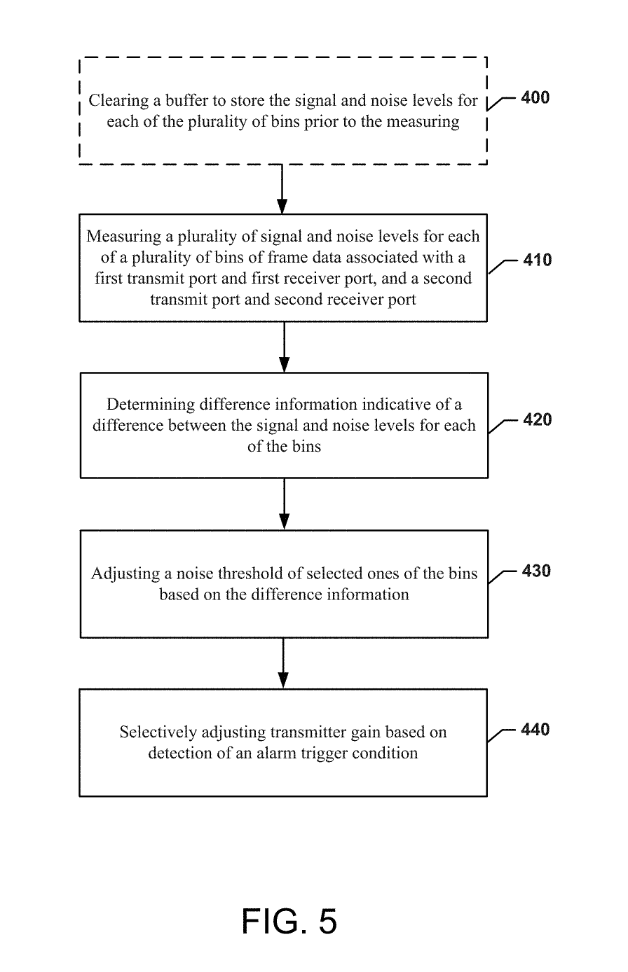

In an example embodiment, the processing circuitry 210 may therefore be configured to receive information indicative of the enablement of an automated tuning function (and resonance noise detection) and execute the corresponding automated tuning. Thus, from a technical perspective, the processing circuitry 210, as described above, may be used to support some or all of the operations described above. As such, the platform described in FIGS. 2 and 3 may be used to facilitate the implementation of several computer program or network communication based interactions. As an example, FIG. 5 is a flowchart of an example method and program product according to an example embodiment. It will be understood that each block of the flowchart, and combinations of blocks in the flowchart, may be implemented by various means, such as hardware, firmware, processor, circuitry or other device associated with execution of software including one or more computer program instructions. For example, one or more of the procedures described above may be embodied by computer program instructions. In this regard, the computer program instructions which embody the procedures described above may be stored by a memory device of a computing device and executed by a processor in the computing device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions. Such programming or instructions may, in some cases, transform the processing circuitry 210 into an automatic system tuning device that measures system response and adjusts system parameters automatically to control the operation of system devices.

In this regard, FIG. 5 illustrates a block diagram showing a method of performing dynamic or automatic tuning associated with resonance noise detection for a tag monitoring device configured to monitor a security tag adapted to be disposed on a corresponding product in a monitoring environment. The monitoring environment may include a transmitter, a receiver and processing circuitry. The transmitter may be configured to transmit a periodic signal pulse (e.g., a high frequency pulse) during a transmit cycle. The receiver may be configured to monitor for a response from the security tag after the transmit cycle. The processing circuitry may be configured to control the receiver with respect to enabling the receiver to detect the response. The processing circuitry is configured to perform dynamic tuning of the receiver or transmitter by measuring a plurality of signal and noise levels for each of a plurality of bins of frame data associated with a first transmit port and first receiver port, and a second transmit port and second receiver port at operation 410, determining difference information indicative of a difference between the signal and noise levels for each of the bins at operation 420, adjusting a noise threshold of selected ones of the bins based on the difference information at operation 430, and selectively adjusting transmitter gain based on detection of an alarm trigger condition at operation 440.

In some embodiments, the features described above may be augmented or modified, or additional features may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, in some cases, the method may further include an initial operation of clearing a buffer to store the signal and noise levels for each of the plurality of bins prior to the measuring at operation 400. In an example embodiment, the tag monitoring device comprises a tag detection pedestal. In an example embodiment, the transmitter may include a first transmitter and a second transmitter, and the receiver comprises a first receiver and second receiver. In an example embodiment, selectively adjusting transmitter gain includes disabling one of the first or second transmitter and enabling the other of the first or second transmitter after a predetermined time, determining whether the alarm trigger condition is detected at a transmit or receive port associated with the one of the first or second transmitter that was disabled, and adjusting transmitter gain in response to determining that the alarm trigger condition is detected. In an example embodiment, adjusting the transmitter gain comprises adjusting the transmitter gain of the one of the first or second transmitter that was disabled by a predetermined amount. In an example embodiment, clearing the buffer comprises processing at least 1000 frames with no adjustments to levels of the transmitter or receiver. In an example embodiment, measuring the plurality of signal and noise levels for each of the plurality of bins comprises averaging a predetermined number of frames (e.g., about 2000 frames) of signal and noise level data for each bin.

Example embodiments may provide a security system that can effectively protect a product to which a security tag is attached from theft, by providing an automatically tunable detection device that minimizes false alarms and maximizes detection capabilities. By enabling the security device to be detected more effectively and with fewer false alarms, effectiveness may be increased while overall satisfaction of a retailer using instances of the security device to protect products may be improved.

Many modifications and other examples of the embodiments set forth herein will come to mind to one skilled in the art to which these embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements or functions, it should be appreciated that different combinations of elements or functions may be provided by alternative embodiments without departing from the scope of the appended claims. In this regard, for example, different combinations of elements or functions than those explicitly described above are also contemplated as may be set forth in some of the appended claims. In cases where advantages, benefits or solutions to problems are described herein, it should be appreciated that such advantages, benefits or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A tag monitoring device configured to interface with a security tag adapted to be disposed on a corresponding product in a monitoring environment, the tag monitoring device comprising:
a transmitter configured to transmit a periodic signal pulse during a transmit cycle;
a receiver configured to monitor for a response from the security tag after the transmit cycle; and
processing circuitry configured to control the receiver to detect the response,
wherein the processing circuitry is configured to perform dynamic tuning of the receiver or transmitter by:
measuring a plurality of signal and noise levels for each of a plurality of bins of frame data associated with a first transmit port and a first receiver port, and a second transmit port and a second receiver port;
determining difference information indicative of a difference between the signal and noise levels for each of the bins;
adjusting a noise threshold of selected ones of the bins based on the difference information; and
selectively adjusting a transmitter gain based on detection of an alarm trigger condition.

2. The device of claim 1, wherein the tag monitoring device comprises a tag detection pedestal.

3. The device of claim 1, wherein the transmitter comprises a first transmitter and a second transmitter, and the receiver comprises a first receiver and a second receiver.

4. The device of claim 3, wherein selectively adjusting transmitter gain comprises:
disabling one of the first or second transmitter and enabling the other of the first or second transmitter after a predetermined time;
determining whether the alarm trigger condition is detected at a transmit or receive port associated with the one of the first or second transmitter that was disabled; and
adjusting transmitter gain in response to determining that the alarm trigger condition is detected.

5. The device of claim 4, wherein adjusting the transmitter gain comprises adjusting the transmitter gain of the one of the first or second transmitter that was disabled by a predetermined amount.

6. The device of claim 5, wherein the processing circuitry is further configured to perform dynamic tuning of the receiver or transmitter by selectively adjusting transmitter gain for the other of the first or second transmitter.

7. The device of claim 1, wherein the processing circuitry is further configured to perform dynamic tuning of the receiver or transmitter by clearing a buffer to store the signal and noise levels for each of the plurality of bins prior to the measuring.

8. The device of claim 7, wherein clearing the buffer comprises processing at least 1000 frames with no adjustments to levels of the transmitter or receiver.

9. The device of claim 8, wherein measuring the plurality of signal and noise levels for each of the plurality of bins comprises averaging a predetermined number of frames of signal and noise level data for each bin.

10. The device of claim 9, wherein the predetermined number of frames is about 2000.

11. A security system comprising:
at least one security tag disposed on a product in a monitoring environment; and
a tag monitoring device configured to interface with the at least one security tag, the tag monitoring device comprising:
a transmitter configured to transmit a periodic signal pulse during a transmit cycle;
a receiver configured to monitor for a response from the security tag after the transmit cycle; and
processing circuitry configured to control the receiver to detect the response,
wherein the processing circuitry is configured to perform dynamic tuning of the receiver or transmitter by:
measuring a plurality of signal and noise levels for each of a plurality of bins of frame data associated with a first transmit port and first receiver port, and a second transmit port and second receiver port;
determining difference information indicative of a difference between the signal and noise levels for each of the bins;
adjusting a noise threshold of selected ones of the bins based on the difference information; and
selectively adjusting transmitter gain based on detection of an alarm trigger condition.

12. The system of claim 11, wherein the tag monitoring device comprises a tag detection pedestal.

13. The system of claim 11, wherein the transmitter comprises a first transmitter and a second transmitter, and the receiver comprises a first receiver and second receiver.

14. The system of claim 13, wherein selectively adjusting transmitter gain comprises:
disabling one of the first or second transmitter and enabling the other of the first or second transmitter after a predetermined time;
determining whether the alarm trigger condition is detected at a transmit or receive port associated with the one of the first or second transmitter that was disabled; and
adjusting transmitter gain in response to determining that the alarm trigger condition is detected.

15. The system of claim 14, wherein adjusting the transmitter gain comprises adjusting the transmitter gain of the one of the first or second transmitter that was disabled by a predetermined amount.

16. The system of claim 15, wherein the processing circuitry is further configured to perform dynamic tuning of the receiver or transmitter by selectively adjusting transmitter gain for the other of the first or second transmitter.

17. The system of claim 11, wherein the processing circuitry is further configured to perform dynamic tuning of the receiver or transmitter by clearing a buffer to store the signal and noise levels for each of the plurality of bins prior to the measuring.

18. The system of claim 17, wherein clearing the buffer comprises processing at least 1000 frames with no adjustments to levels of the transmitter or receiver.

19. The system of claim 18, wherein measuring the plurality of signal and noise levels for each of the plurality of bins comprises averaging a predetermined number of frames of signal and noise level data for each bin.

20. The system of claim 19, wherein the predetermined number of frames is about 2000.
